(19) United States
(12) Patent Application Publication
(10) Pub. No.: US 2010/0169073 A1
(43) Pub. Date: Jul. 1, 2010

(54) Foldable Wireless Device for Language Translation

(75) Inventor: Irving Almagro, Irvine, CA (US)

Correspondence Address: Irving Almagro, 2906 Simplicity, Irvine, CA, 92620, US

(73) Assignee: VOICE MUFFLER CORPORATION, Irvine, CA (US)

(21) Appl. No.: 12/651,313

(22) Filed: Dec. 31, 2009

Related U.S. Application Data
(60) Provisional application No. 61/142,136, filed on Dec. 31, 2008.

(51) Int. Cl. G06F 17/28

(52) U.S. Cl. 704/3; 704/277

(57) ABSTRACT

A foldable handheld communication device with a clamshell housing which when used is unfolded to cover the mouth area of a user wherein such arrangement allows said device to be portable and be stored in a pocket or purse. Said device comprises a microphone to capture speech, a transceiver to transmit and receive signals, and a loudspeaker to deliver a received translated speech to a person other than said user.

### RELATED APPLICATION

This application claims priority date under 35 U.S.C..sctn. 119(e) from the following U.S. provisional application: Application Ser. No. 61/142,136, titled “Foldable Wireless Sound Muffled Device for Language Translation,” filed on Dec. 31, 2008.

### BACKGROUND OF THE INVENTION

The present invention relates generally to wireless communications, passive sound muffling of the user's voice, and more particularly to the realtime speech-to-speech translation between peoples who speak different languages.

The reporting device or Stenomask that was patented over 20 years ago in Gore, U.S. Pat. No. 4,129,754 provided a viable solution in reducing undesirable sounds when using a microphone in ruckus adverse environments such as courtrooms. The Stenomask or voice muffled device has been found to be an excellent apparatus for speech recognition systems due to: 1) its microphone is positioned at a constant distance from the speaker's mouth which is an essential criterion in achieving a high rate of recognition success, and 2) it stopped outside noise from being captured by the microphone thereby reducing signal distortion.

There are currently numerous devices with a transceiver that facilitates wireless communications from a native person to a foreigner and such devices incorporate a microphone to receive the user's speech which is translated and later heard by a foreigner through a loudspeaker on the same device. Some examples of such devices include the Praselator made by Voxtec and iTRAVL electronic translators by Ectaco. However, it is common knowledge that undesirable sounds are emanated when a user speaks into a device having an open microphone. For example, if an English speaker speaks into these devices, the foreigner will be able to hear the English words before he is able to hear the translated words. Such unwanted sounds can be very distracting especially when the translation becomes so fast causing the jumbling of the English words with the translated language. Such a situation obviously will cause confusion and a failure in effecting a useful conversation between the two people.

Bluetooth wireless technology is a short-range communications technology intended to replace the cables connecting portable and/or fixed devices while maintaining high levels of security. WiMAX, LTE and similar broadband technology provide long range telecommunications for portable devices. WiFi and Wireless USB technology facilitate the telecommunications of voice and data signals to computer systems. UHF, VHF, microwave and other radio transceiver technologies convert and reproduce audio and digital signals into radio waves to facilitate telecommunications.

Thus, embedding a Bluetooth, WIFI, WiMAX, Wireless USB or other wireless RF transceiver inside a foldable sound muffled device with a microphone, send a user's speech and then receive a translated version where it is fed to a loudspeaker for a foreigner to hear. Furthermore, fix an external microphone on said device, transmit a foreigner's speech and later receive the translation and output it to an earphone for a user to hear. Such an arrangement would manifestly provide a user a convenient, quieter, and effective interlingual communications apparatus. Further, a touchscreen display incorporated into the device would provide enhanced functionalities such as translation error verification and correcting, accessing the internet or dialing to a remotely located language translation service provider.

### OBJECTS OF THE INVENTION

It is therefore an object of the invention to provide a portable folding device that can dampen unwanted vocal sounds from a user speaking a certain language; utilize the Bluetooth or other wireless systems in conveying the user's speech, captured by the internal microphone, to a remote translation facility and have either a human or machine translator translate the speech into a desired language; receive the translated speech; and convert said speech into an audible sound by outputting it to a loudspeaker that can be heard by a foreigner. Further, said invention is to allow the speech of the secondary speaker to be captured by the microphone located on the external part of the device; send the speech signal to a remote translation facility; receive translated speech utilizing the device's transceiver system; and output said speech by means of the device's earphone circuitry to be heard by the user.

A further object of the invention is to provide a wireless voice muffled translator that can include a video camera and display system to enhance the translation effectiveness.

A further object of the invention is to provide a wireless voice muffled translator that can effectively eliminate unwanted sounds by incorporating a removable sound absorbing interior housing or baffle component.

A further object of the invention is to provide a wireless voice muffled translator wherein the translated output or other information can be displayed in a text or graphic format onto a touchscreen display for translation error correction capability or other enhanced functions.

A further object of the invention is to provide a wireless voice muffled translator that can be attached to a lanyard, Velcro or other fasteners for ease of portability.

A further object of the invention is to provide a wireless voice muffled translator having a vent to release internal pressure.

### SUMMARY OF THE INVENTION

In an exemplary embodiment, the present invention comprises a generally rigid housing with sound absorbing components defining a clamshell, further comprising: a microphone for receiving a user's speech and another microphone for receiving a foreigner's speech; a transceiver for transmitting untranslated speech and receiving translated speech; a loudspeaker for outputting the translated speech to be heard by a foreigner; and a corded or cordless earphone to allow the user to hear the foreigner's translated speech.

In another exemplary embodiment, the present invention comprises a generally rigid housing with sound absorbing attributes defining a clamshell, further comprising: a microphone for receiving a user's speech and another microphone for receiving a foreigner's speech; a transceiver for transmitting untranslated speech and receiving translated speech; a loudspeaker for outputting the translated speech to be heard by a foreigner; a corded or cordless earphone to allow the user to hear the foreigner's translated speech; and a video camera and display system with or without touchscreen capability to enhance the interlingual communications process.

### BRIEF DESCRIPTION OF THE DRAWINGS

FIG. 1 is a pictorial representation of a prior art problem when an English speaker communicates with a foreigner using a translation device with an open microphone.

FIG. 2 is a pictorial representation of how an embodiment of the invention solves the language translation problem of the prior art.

FIG. 3 is a pictorial representation of how a person would typically use the device with a corded earphone in accordance with an embodiment of the invention.

FIG. 4 is a pictorial representation of how a person would typically use the device with a wireless or cordless earphone in accordance with an embodiment of the invention.

FIG. 5 is a front elevational view of an I/O assembly of an embodiment of the invention.

FIG. 6 is a rear elevational view of an I/O assembly of an embodiment of the invention.

FIG. 7 is a side sectional view of an I/O assembly of an embodiment of the invention.

FIG. 8 is a perspective view of an I/O assembly of an embodiment of the invention.

FIG. 9 is a front elevational view of an embodiment of the invention showing a clamshell assembly in the closed position.

FIG. 10 is a side elevational view of an embodiment of the invention showing a clamshell assembly in the closed position.

FIG. 11 is a rear elevational view of an embodiment of the invention showing a clamshell assembly in the closed position.

FIG. 12 is a top plan view of an embodiment of the invention showing a closed clamshell assembly linked to the I/O assembly by hinges located on the outside edges of their housings.

FIG. 13 is a top plan view of an embodiment of the invention showing an open clamshell assembly linked to the I/O assembly by hinges located on the outside edges of their housings.

FIG. 14 is a side view of a first clamshell portion showing its internal components and a side sectional view of an attached I/O assembly.

FIG. 15 is a side view of a second clamshell portion showing its internal components and a side sectional view of an attached I/O assembly.

FIG. 16 is a front sectional view of an embodiment of the invention showing the clamshell assembly in a closed arrangement.

FIG. 17 is a front sectional view of an embodiment of the invention showing the clamshell assembly in a partially opened arrangement.

FIG. 18 is a front sectional view of an embodiment of the invention showing the clamshell assembly in an open arrangement.

FIG. 19 is a top sectional view of an embodiment of the invention showing the clamshell assembly in an open arrangement.

FIG. 20 is a perspective front view of an open clamshell assembly linked to an I/O assembly with hinges on the outside edges of both assemblies.

FIG. 21 is a perspective rear view of an open clamshell assembly with linked to an I/O assembly with hinges on the outside edges of both assemblies.

FIG. 22 is a top plan view of a dual hinge rectangular tubing in an embodiment of the invention.

FIG. 23 is a front elevational view of a dual hinge rectangular tubing in an embodiment of the invention.

FIG. 24 is a side elevational view of a dual hinge rectangular tubing in an embodiment of the invention.

FIG. 25 is a perspective view of a dual hinge rectangular tubing in an embodiment of the invention.

FIG. 26 is a perspective detail view of a dual hinge tubing shown relative to the I/O assembly as viewed from the side of a removed closed clamshell assembly.

FIG. 27 is a perspective detail view of a dual hinge tubing shown relative to the I/O assembly as viewed from the side of a removed extended clamshell assembly.

FIG. 28 is a perspective detail view of a dual hinge tubing shown relative to a closed clamshell assembly as viewed from the side of a removed I/O assembly.

FIG. 29 is a perspective detail view of a dual hinge tubing shown relative to an extended clamshell assembly as viewed from the side of a removed I/O assembly.

FIG. 30 is a top plan view of an embodiment of the invention showing a closed clamshell assembly utilizing a dual-hinged tubing linked to an I/O assembly.

FIG. 31 is a top plan view of an embodiment of the invention showing a partially closed clamshell assembly utilizing a dual-hinged tubing linked to an I/O assembly.

FIG. 32 is a top plan view of an embodiment of the invention showing an open clamshell assembly utilizing a dual-hinged tubing with the I/O assembly being pushed outwards.

FIG. 33 is a top plan view of an embodiment of the invention showing the I/O assembly still in an extended position after the clamshell assembly utilizing a dual-hinged tubing had been placed in a closed position.

FIG. 34 is a side elevational view of an embodiment of the invention showing a closed clamshell assembly utilizing a dual-hinged tubing linked to an I/O assembly.

FIG. 35 is a side elevational view of an embodiment of the invention showing a partially closed clamshell assembly utilizing a dual-hinged tubing linked to an I/O assembly.

FIG. 36 is a side elevational view of an embodiment of the invention showing an open clamshell assembly utilizing a dual-hinged tubing with the I/O assembly being pushed outwards.

FIG. 37 is a side elevational view of an embodiment of the invention showing the I/O assembly still in an extended position after the clamshell assembly utilizing a dual-hinged tubing had been placed in a closed position.

FIG. 38 is a top sectional view of an embodiment of the invention showing a closed clamshell assembly utilizing a dual-hinged tubing linked to an I/O assembly.

FIG. 39 is a top sectional view of an embodiment of the invention showing a partially closed clamshell assembly utilizing a dual-hinged tubing linked to an I/O assembly.

FIG. 40 is a top sectional view of an embodiment of the invention showing an open clamshell assembly utilizing a dual-hinged tubing with the I/O assembly being pushed outwards.

FIG. 41 is a top sectional view of an embodiment of the invention showing the I/O assembly still in an extended position after the clamshell assembly utilizing a dual-hinged tubing had been placed in a closed position.

FIG. 42 is a side sectional view of an embodiment of the invention showing a closed clamshell assembly utilizing a dual-hinged tubing linked to an I/O assembly.

FIG. 43 is a side sectional view of an embodiment of the invention showing an open clamshell assembly utilizing a dual-hinged tubing with the I/O assembly being pushed outwards.

FIG. 44 is a side sectional view of an embodiment of the invention showing the I/O assembly still in an extended position after the clamshell assembly utilizing a dual-hinged tubing had been placed in a closed position.

FIG. 45 is a front perspective view of an embodiment of the invention showing a closed clamshell assembly utilizing a dual-hinged tubing linked to an I/O assembly.

FIG. 46 is a front perspective view of an embodiment of the invention showing a partially closed clamshell assembly utilizing a dual-hinged tubing linked to an I/O assembly.

FIG. 47 is a front perspective view of an embodiment of the invention showing an open clamshell assembly utilizing a dual-hinged tubing with the I/O assembly being pushed outwards.

FIG. 48 is a front perspective view of an embodiment of the invention showing the I/O assembly still in an extended position after the clamshell assembly utilizing a dual-hinged tubing had been placed in a closed position.

FIG. 49 is a rear perspective view of an embodiment of the invention showing a closed clamshell assembly utilizing a dual hinged tubing linked to an I/O assembly.

FIG. 50 is a rear perspective view of an embodiment of the invention showing an open clamshell assembly utilizing a dual hinged tubing with the I/O assembly being pushed outwards.

FIG. 51 is a rear perspective view of an embodiment of the invention showing the I/O assembly still in an extended position after the clamshell assembly utilizing a dual-hinged tubing had been placed in a closed position.

FIG. 52 is a top plan view of another embodiment of the invention showing the clamshell assembly in a closed position with the shells linked together by a single hinge located in the middle and the I/O assembly being linked with the clamshell assembly by guide rods.

FIG. 53 is a top plan view of another embodiment of the invention showing the clamshell assembly in an open position with the shells linked together by a single hinge located in the middle and the I/O assembly being linked to the clamshell assembly by guide rods.

FIG. 54 is a side elevational view of an embodiment of the invention shown with the earphone wires coiled around the I/O assembly.

FIG. 55 is a side sectional view of an embodiment of the invention shown with the earphone wires utilizing a retractable assembly.

FIG. 56 is a front perspective view of another embodiment of the invention shown in a closed clamshell assembly with a display screen on the outside of a shell portion.

FIG. 57 is a rear perspective view of another embodiment of the invention showing an I/O assembly with a video camera component.

FIG. 58 is a flowchart diagram summarizing a speech-to-speech language translation function in accordance with an embodiment of the invention.

FIG. 59 is a diagram of a typical operational mode of the wireless device in accordance with an embodiment of the current invention.

FIG. 60 is a diagram of another typical operational mode of the wireless device in accordance with an embodiment of the current invention.

### DETAILED DESCRIPTION OF THE PREFERRED EMBODIMENT

As used herein, the term “user,” or “first person,” is intended but not limited, to generally refer to a person who is operating or manipulating or holding or grasping, or a combination thereof, a wireless device having a purpose of effecting a translation of his or her speech.

As used herein, the term “foreigner,” or “second person,” is intended but not limited, to generally refer to someone who speaks a language that is different from a user. A foreigner can also be a person who is not operating nor manipulating nor holding nor grasping, nor a combination thereof, a wireless translation device.

As used herein, the term “housing” is intended but not limited, to generally refer to a metallic or non-metallic or a combination of both, protective cover, casing, case, shell or enclosure designed to contain, enclose or support another housing, mechanical, electrical, electronic components, and/or any combination thereof. It can be homogeneous, heterogeneous, multi-layered, multi-bodied, multi-frame, multi-colored and/or any combination thereof. It may be rigid, semi-rigid, flexible, supple, and/or a combination thereof. It may also have properties such as sound absorbing, soundproofing, sound muffling, sound baffling, sound distorting, anti-bacterial, germicidal, anti-viral, anti-odor, electromagnetic shielding, radiation shielding, and/or a combination thereof.

As used herein, the term “assembly” is intended but not limited, to generally refer to a unit consisting of components that have been fitted together wherein said components can comprise of a machine part, electrical part, computer part, electronic part, housing, enclosure, sound absorbing material, power supply, antenna, and/or any combination thereof.

As used herein, the term “transceiver”, “transceiver system”, “transceiver unit” or “transceiver module,” is intended but not limited, to generally refer to a wireless or radio frequency system having electronic components and circuitry such as a transmitter, receiver, CODEC, DAC, Advanced RISC Machine (ARM) CPU, computer, image or video processor, application processor, memory, voice recognizer, sound quality optimizer, telephone number dialing circuitry, antenna, power supply, battery, battery charger, timer, test circuitry, amplifier, digital and analog processors, AF or RF signal conditioners, other associated mechanical, electronic and electrical components, and/or any combination thereof, the main function of which is: to transmit analog and/or digital signals; and to receive analog and/or digital signals. It should be further understood that it is a common practice in the electronics industry to use expansion slots, adapters, sockets, connectors, and/or any combination thereof, with the goal of providing robustness and extensibility of the transceiver by adding enhancement capabilities and new functionalities of their hardware products. An example of this is the PC's modem whereby they have now been integrated into the PCs CPU instead of being an external device with its own power supply. As well, some components of the transceiver do not necessarily have to stay enclosed within the module for it to qualify as a transceiver. For example, to lengthen the transceiver's usage, a battery pack can be added, and to extend its range a RF amplifier and longer antenna can be added, externally. Other examples include SIM cards, SD memory cards, CF memory cards, amplifiers, firmware ROMs, etc. These additional components are associated with the transmitting and receiving functions and are therefore considered integral parts of the “transceiver” and thus may not need to be specified as separate components. Further, due to the rapid advances in the semiconductor industry with regards to miniaturization, it is further understood that more and more discrete components are being integrated and made modular therein. For example, most PC practitioners refer to the CPU as just the computer chip, and related supporting circuits such as a digital communications controllers I/O controller, firmware ROM, timing circuits, cache controller, were considered separate or discrete components. Nowadays, the CPU is composed of all these formerly discrete components that have been integrated or modularized into a single chip or module. Similarly, the transceiver has been constantly transitioned into a modularized structure and therefore understood that the term also encompasses, but not limited, to the integration and modularization of discrete components that relate to the function of transmitting and/or receiving analog/digital signals. Some wireless base stations are also considered as transceivers since their main function is to receive and transmit data in addition to signal processing and conditioning.

As used herein, the term “multifunction key,” or “multi-key” is intended but not limited, to generally refer to a push button switch which allows the invention to be powered up or powered down, pair with compatible wireless devices, run a self-test or bootup routine, as well as other tasks associated with the efficient functioning and high performance of the transceiver system. The multi-key starts up and maintains the process of getting power to the transceiver from the power source, typically a battery, or starting a standby timer which powers down the transceiver after a set period of time, a function also known as auto-shutoff used for conserving the device's battery. This key can also power down the device when the user depresses it for a few seconds. Additionally, this key may also be associated or integrated with small indicator lamps which provide status information of the wireless device. It is understood that new functions are continually added to this component to enhance the transceiver's capabilities, so implementing these enhancements on the current invention would be embraced and considered as a normal progression or transition of its technology.

As used herein, the term “microphone” is intended but not limited, to generally refer to a device or an instrument that converts sound waves into an electric current, usually fed into a sound processor, an amplifier, a recorder, or a broadcast transmitter. It can also be an instrument used to capture audio waves from a user of an electronic device such as a wireless language translator, a cellphone, a mobile phone, a wireless headset and other speech input devices. A microphone can also be any type depending upon the manufacturer's or the user's preference—whether it be sound quality, noise canceling capability, weight and/or cost consideration, size, ruggedness, and/or a combination thereof. It is understood that the microphone technology is constantly evolving and improving which therefore makes it very conceivable that the microphone used in the present invention may adopt all the aforementioned enhancements and/or improvements thereof.

As used herein, the term “earphone,” or “earbud,” or “headphone,” or “in-ear headphone,” is intended but not limited, to generally refer to a device or an instrument that converts electrical signals into audible waves or sounds, of a size that is generally small or adjustable, lightweight, corded or cordless, with or without a hook, and/or a combination thereof, which allows a typical person to wear said device on or in his ear. It can have features such as high sound quality, automatic volume control, enhanced equalizer, noise canceling capability, ultra lightweight, interchangeable or replaceable cushion cover, miniaturized size, ruggedness, and/or a combination thereof. It is understood that the earphone technology is constantly evolving and improving which therefore makes it very understandable that the earphone used in the present invention may adapted or replaced by advanced or improved models thereof.

As used herein, the term “I/O,” or “I/O component,” or “I/O device,” is intended but not limited, to generally refer to a device, unit or group of units used by a person (or other system) to communicate or interface with an analog, video or digital circuits or processors. For instance, microphone and CCD lens are considered input devices of a mobile phone, while screen displays and loudspeakers are considered output devices of a mobile phone. Devices for communication between processors, such as transceivers, modems and codecs, typically serve for both input and output.

As used herein, the term “battery” is intended but not limited, to generally refer to a direct-current voltage source made up of one or more units that convert chemical, thermal, nuclear, mechanical or solar energy into electrical energy. It can be disposable but it is preferred that the present invention uses a rechargeable type. If it is of the rechargeable type, the term “battery” may refer to a rechargeable battery with its related charging circuitry which can comprise an AC adapter, a rectifier, a passive filter, an active filter, a timer, an overcharging protector, and/or a combination of other related battery recharging electronics. It is understood that the battery technology is constantly evolving and improving, therefore the type or kind of battery that the present invention may adopt will depend on the application's or manufacturer's preference.

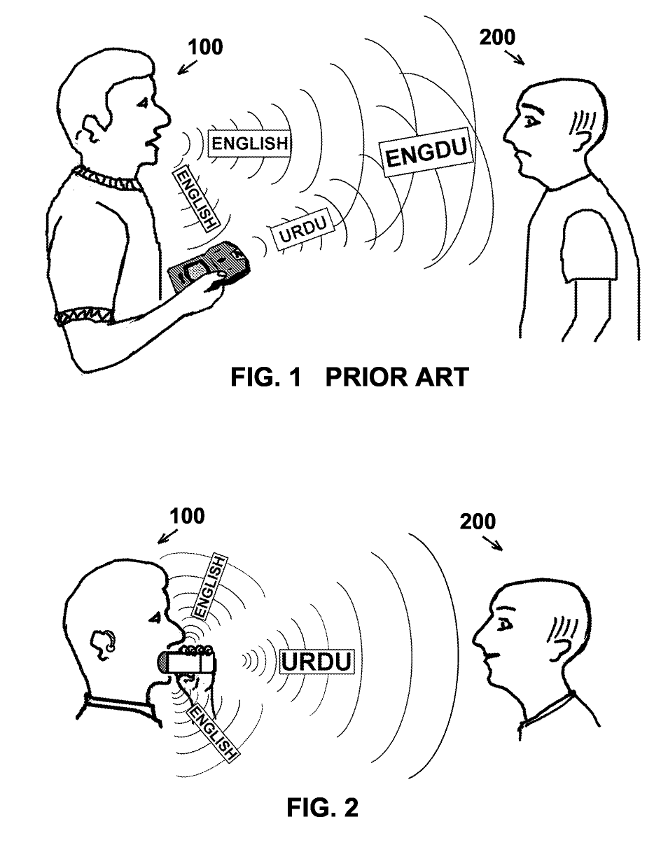

FIG. 1 illustrates the prior art example of an English language speaker or user seen as general reference 100, communicating with a second person or foreigner, seen as general reference 200, who speaks the Urdu language using a handheld automatic translation system. As shown, user 100 is using a device with an open microphone causing undesirable sounds to be emanated while he is speaking. In a situation such as the aforementioned, the foreigner 200 would first hear the spoken English language and then a short while later hear the translated Urdu language. This translation method becomes very undesirable, especially in situations wherein the language translation becomes almost instantaneous, because both languages would get jumbled or mixed together thereby confusing the foreigner 200.

FIG. 2 shows how the invention 10 solves the prior art problem by letting the listener hear most of the translated speech only and very little of the untranslated speech. This is done by confining the voice of the English speaker 100 inside a sound muffling device comprising a microphone which captures the user's speech, a transmitter to send the speech to a remote language translation system, a receiver to capture the translated speech, and a loudspeaker to output the translation that the foreigner 200 can hear intelligibly since there are no English sounds that could get mixed with the Urdu sounds.

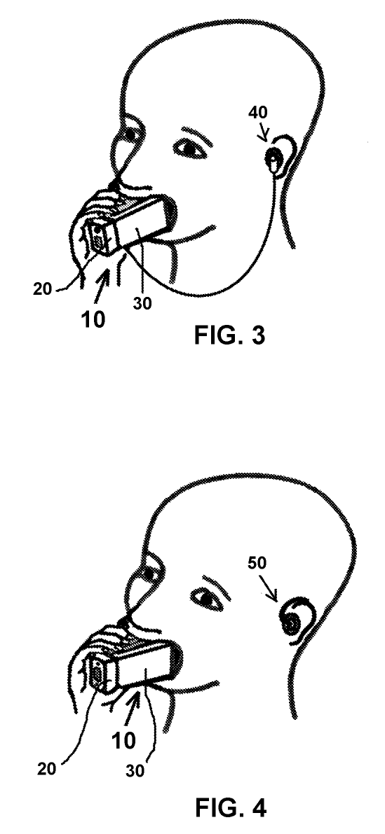

FIGS. 3 and 4 show the present invention, seen as general reference 10, comprising of an I/O assembly 20 and a clamshell assembly 30 whereby I/O 20 encloses the input and output functions for a foreigner 200 and clamshell 30 encloses the input and sound blocking functions of a user 100. In FIG. 3, invention 10 is shown being in the open position, such as during its normal usage, pressed comfortably against the user's face covering the mouth area thereby allowing clamshell 30 to capture the user's speech and at the same time blocking as much of the sounds that the user vocalizes. Earphone 40, which is linked to the transceiver by a cable, a cord or wires, allows the user to hear or monitor his speech input and/or the translated speech. The invention 10 can also use a compatible wireless headset 50 as a substitute for earphone 40 as shown in FIG. 4.

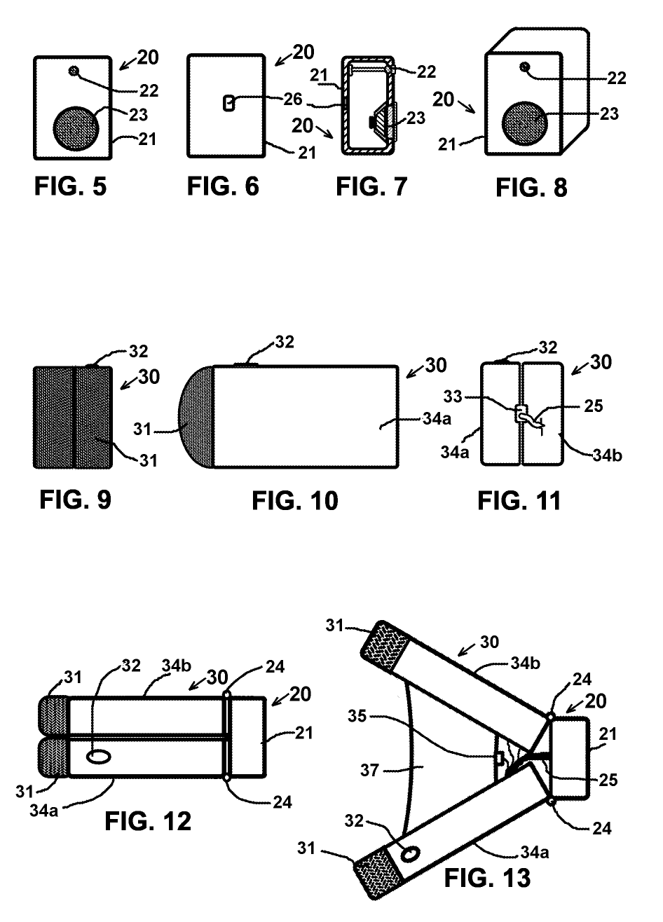

FIGS. 5-8 show different views of the I/O assembly 20 comprising a housing 21, a rear opening 26, a microphone 22 and a loudspeaker 23. The opening 26 allows for a cable, wires, or wiring harness 25 to pass through from the I/O 20 to the clamshell 30. Microphone 22 is outwardly directed to allow the capturing of the speech from a second person 200. Loudspeaker 23 outputs the translated speech that had been amplified to a level that is suitable for a foreigner 200 to hear.

FIGS. 9-11 illustrate the different views of the clamshell 30 comprising: a first shell 34a and a second shell 34b; cushions 31; a multi-key 32; and an opening 33. The shells 34a and 34b are generally having the same size, shape, thickness, and stiffness dimensioned to be grasped comfortably by a user. A clamshell configuration is defined when shells 34a and 34b are linked rotatably on one end, referred to as the rear or hinged end, and the other end is allowed to open freely, referred to as the front or mouth end. Shells 34a and 34b are generally symmetrical and can therefore be interchangeable. The cushions 31 are generally composed of soft, hypo-allergenic, formable materials, with somewhat semicircular, rectangular or face fitting contour shapes, fixed to the front end or mouth area of the clamshell 30, to reduce discomfort when the device 10 is in contact with the user's face during regular usage. Cushions 31 can also be of rubbery, elastic, and smooth materials that are removable or replaceable. Multi-key 32 provides for the powering, pairing of wireless devices and the basic transceiver functions of the invention. A suitable opening 33 allows a cable 25 to pass through between the clamshell 30 and the I/O 20.

Shown in FIGS. 12 and 13 are the top views of the device 10, in the closed and open positions respectively, with hinges 24 located on the outer edges of shells 34a and 34b attached to corresponding edges on the I/O 20 thereby rotatably linking the I/O 20 with clamshell 30. In the open position, the sound muffler component 37 and microphone 35 are revealed. Sound muffler 37 is generally formable, washable, sound-absorbing, sound inhibitor and/or a combination thereof. Further, muffler 37 can be either truncated or not, of a hollow conical or pyramidal shape, intended to maximize sound absorption or sound inhibition. Muffler 37 can also be made of canvas or similar woven fabric with sound blocking and/or sound-absorbing properties. In an alternative embodiment, muffler 37 may be omitted and instead the sound blocking or sound-absorbing capabilities of the device 10 may be accomplished by embedding sound absorbing/blocking materials onto the shells 34a and 34b themselves. A removable or replaceable foam-like material, preferably with self-adhesive properties, may also be used instead of the muffler 37.

Microphone 35 is shown fixed onto the rear exterior portion of the muffler 37. However, it is also a preferred embodiment that microphone 35 be optimally positioned inside muffler 37 with some means of suppressing echo or noise or sibilance or plosives or a combination thereof. Some of these suppressing means include a pop screen and use of noise-cancelling type microphones.

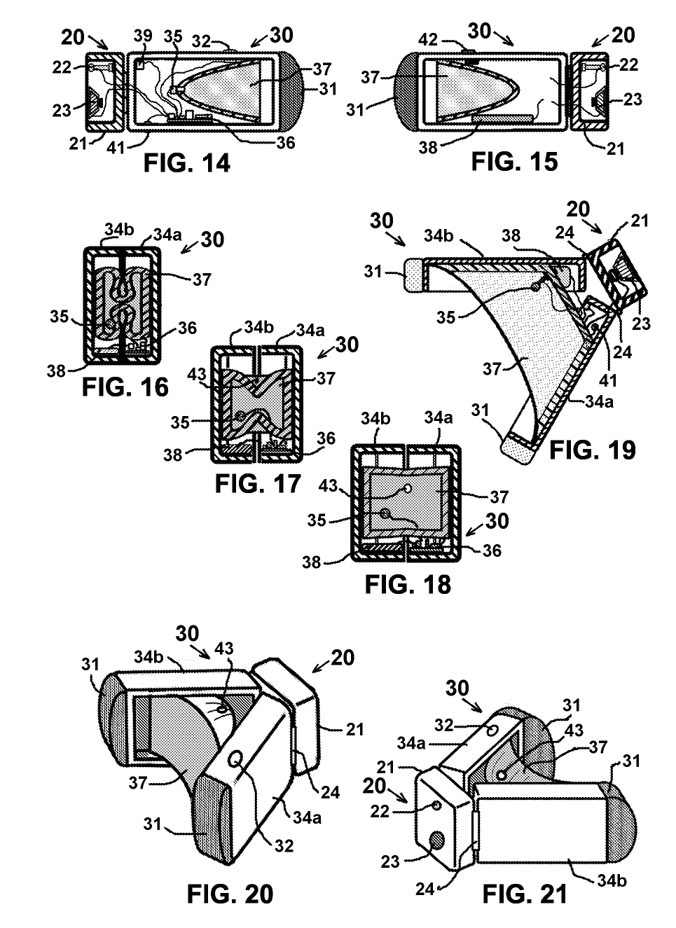

FIGS. 14-19 illustrate the different sectional views of the invention 10 wherein additional elements are revealed inside the clamshell assembly 30, namely, transceiver 36, battery 38, sensor 39, AC charging socket 41, and an optional latch release button 42. The transceiver 38 provides all the electrical and/or electronics functionings and processes involved in the transmission and reception of speech signals of a user 100 and a foreigner 200. Battery 38 provides the power to the invention 10. A sensor 39 allows the device 10 to determine if the clamshell 30 is open, indicating that the user is using said device. FIGS. 20 and 21 are perspective views of an embodiment of invention 10 using two hinges 24 positioned on the outer edges of the I/O 20 and clamshell 30 assemblies.

Although the clamshell 30 can be opened simply by separating the shells 34a and 34b at the mouth end by hand, alternatively, a locking or latch system with a latch release mechanism may be implemented for added convenience. Such alternative latch arrangement can consist of mechanical linkages such as springs, rods, hooks, and pivots whereby a pushbutton 42, optimally positioned on the exterior of the clamshell 30, when depressed disengages a hook that secures the shells 34a and 34b together, allowing the clamshell 30 to swing open. Closing the clamshell 30 manually, such as bringing the open mouth ends together, engages a hook that latches the shells 34a and 34b together. A vent 43 can also be incorporated on the muffler 37 to lessen the sound pressures that may build up inside.

The switch or sensor 39 is generally in the open electrical state when the device 10 is folded up or is not being used, and causes the circuitry in the wireless transceiver 36 to place the device 10 into a standby or suspended mode. Invention 10 stays in the standby mode until the system times out and powers the system down due to inactivity, the length of such inactivity being usually dependent on the preset auto shutoff feature of the transceiver system 36, or until the user 100 decides to manually power down the device 10, in which case a shutdown condition is effected by keeping the multi-key 28 continuously depressed for a few seconds.

When the device 10 is opened or unfolded, such as making or answering a call, sensor 39 detects the changed state and electrically closes the open circuit causing the device 10 to switch to an operational mode thereby allowing the microphone to accept the user's voice which consequently sends the output signal to a remote device for processing.

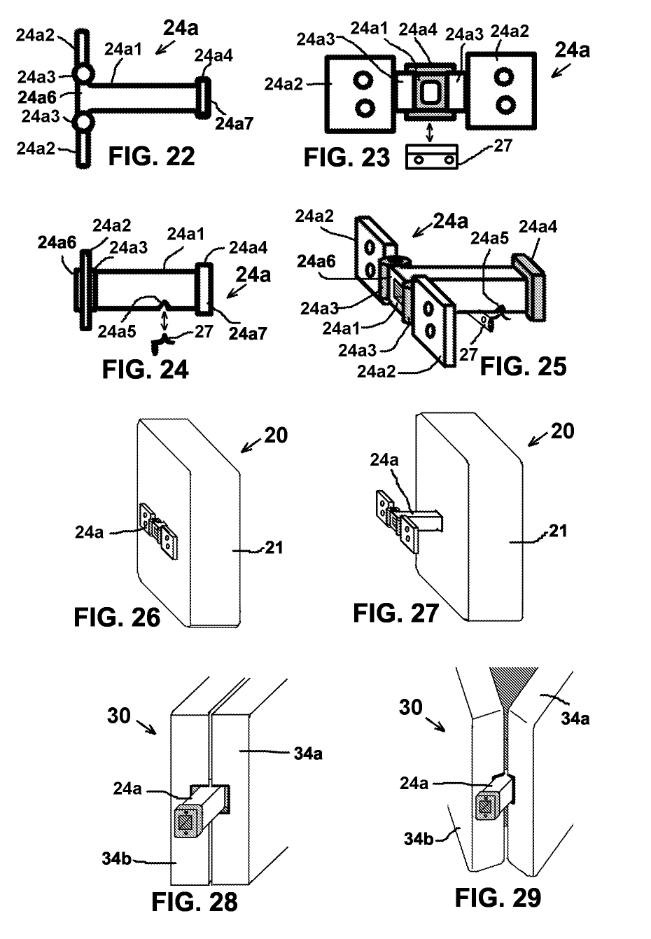

FIGS. 22-25 are views depicting a dual hinge system 24a that rotatably links an I/O 20 to a clamshell 30 comprises: a tubing 24a1, leaves 24a2, and pintles 24a3. Tubing 24a1 is generally a hollow tube element with a first end 24a6 comprising: a first hinge having a leaf 24a2 and a pintle 24a3 fixed at one side; and a second hinge having a leaf 24a2 and a pintle 24a3 fixed at the other side. No hinge is placed on either the top or the bottom sides of the tubing 24a1. As viewed from the top, FIG. 22 shows a “T” shape of the hinge system 24a when the leaves 24a2 extend outwards perpendicular to the tubing's alignment. Further, a rectangular shape is preferred for the tubing 24a1 as it helps keep the I/O 20 from improperly rotating about relative to the clamshell 30. Stop collar 24a4 located on the second end 24a7 may be incorporated with the hinge 20 to limit the distance of travel for the I/O 20. A locking mechanism comprises a spring-loaded tab 27, positioned on the interior of housing 21, and a corresponding notch 24a5, located on the tubing 24a1, ensures the tubing 24a1 to be locked in place when clamshell 30 is in a closed position. Further, the tension of spring 27 should be loose enough such as not to cause any damage when an extruding force or action, such as opening the clamshell 30, is applied.

Viewing from the side of a transparent closed clamshell 30, FIG. 26 provides a somewhat detail view of the position of hinge leaves 24a2 relative to an I/O 20. FIG. 27 shows the position of leaves 24a2 as being a few distance away from the I/O 20 after clamshell 30 was opened. Further, viewing from the side of a transparent I/O 20, FIG. 28 illustrates the position of the stop collar 24a4 relative to a closed clamshell 30, and FIG. 29 shows the stop's 24a4 position relative to an open clamshell 30.

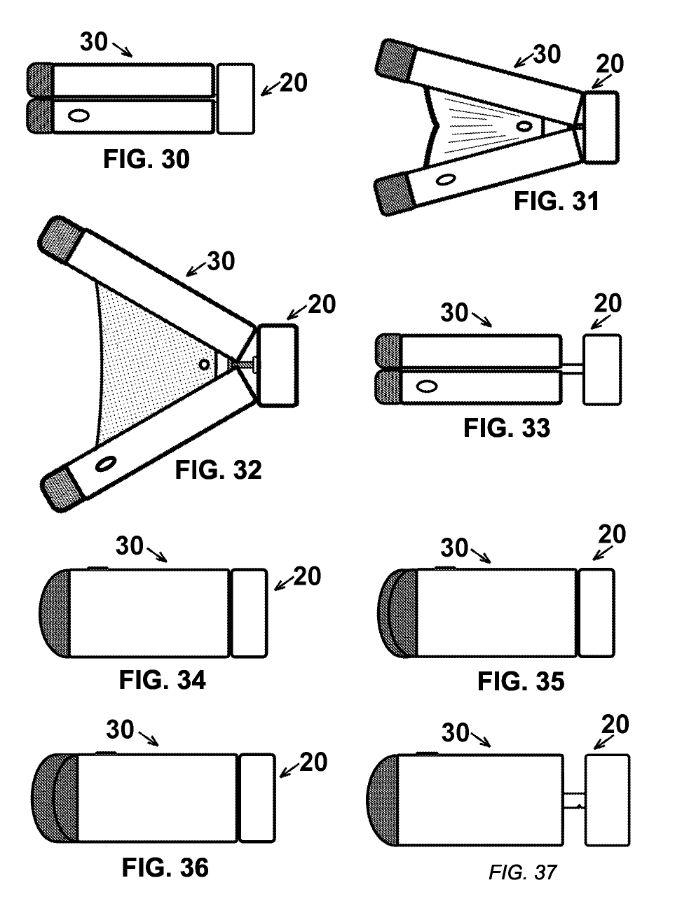

FIGS. 30-33 are top plan views showing the relative distances between an I/O 20 and a clamshell 30 at various arrangements of the latter. For example, as shown on FIG. 30 whereby clamshell 30 is in a closed arrangement, the front of I/O 20 is in general physical contact with the rear of clamshell 30. As the clamshell opens slightly, the first end 24a6 of hinge system 24a can be seen to have moved a short distance away from the rear periphery of I/O 20. With the clamshell 30 wide open, the hinge's first end 24a6 has also moved further away from the I/O 20. The last sequence shows the I/O 20 remaining at the wide open distance from the clamshell 30 and the user only needs to press or push the I/O 20 towards the clamshell 30 whereby both assemblies butt against each other to conclude in a nested arrangement as shown in FIG. 30.

FIGS. 34-37 are the side views of the relative distances between the I/O 20 and the clamshell 30 based on the elucidation provided in paragraph 98 above.

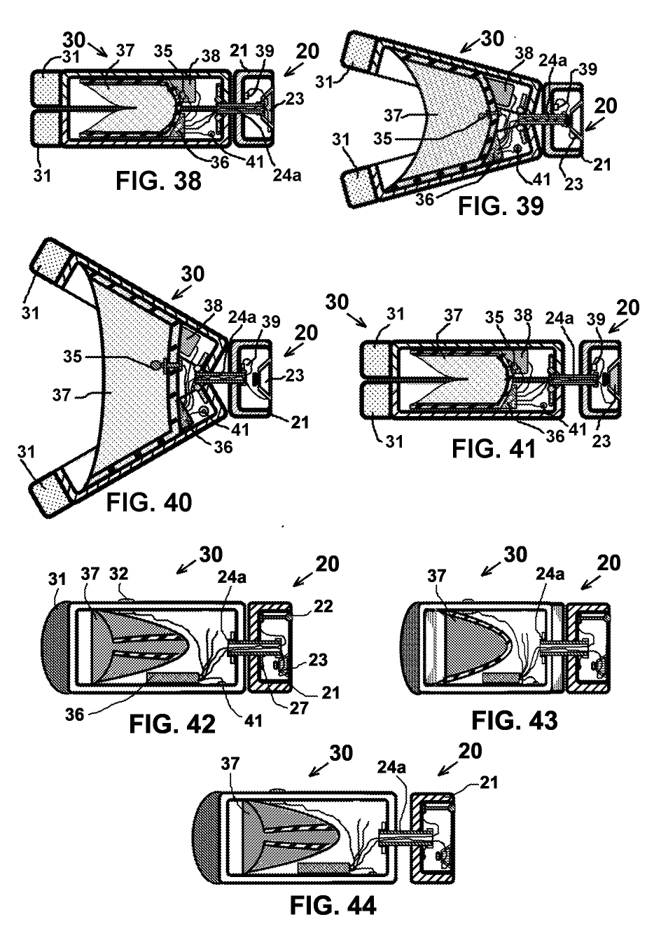

FIGS. 38-41 further detail the distance relationships by providing sectional views of the I/O 20, hinge 24a and clamshell 30 using similar explanations provided in paragraph 98. FIGS. 42-44 similarly further detail the distance relationships of the invention's 10 assemblies by providing sectional views of the I/O 20, hinge 24a, and clamshell 30.

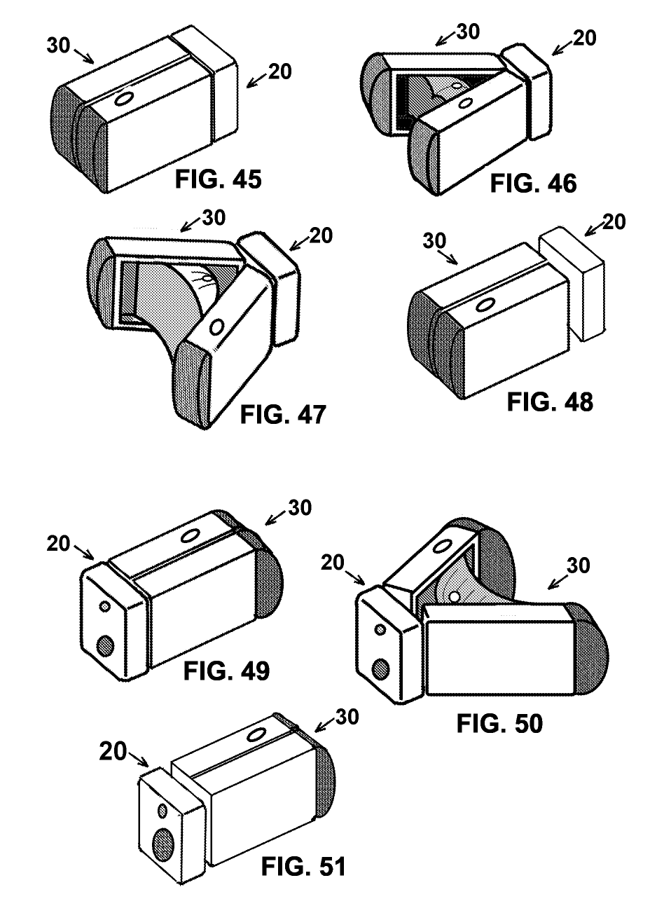

FIGS. 45-48 are the perspective front views of the invention's 10 distance relationships using similar explanations provided in paragraph 98, while FIGS. 49-51 provide the perspective rear views.

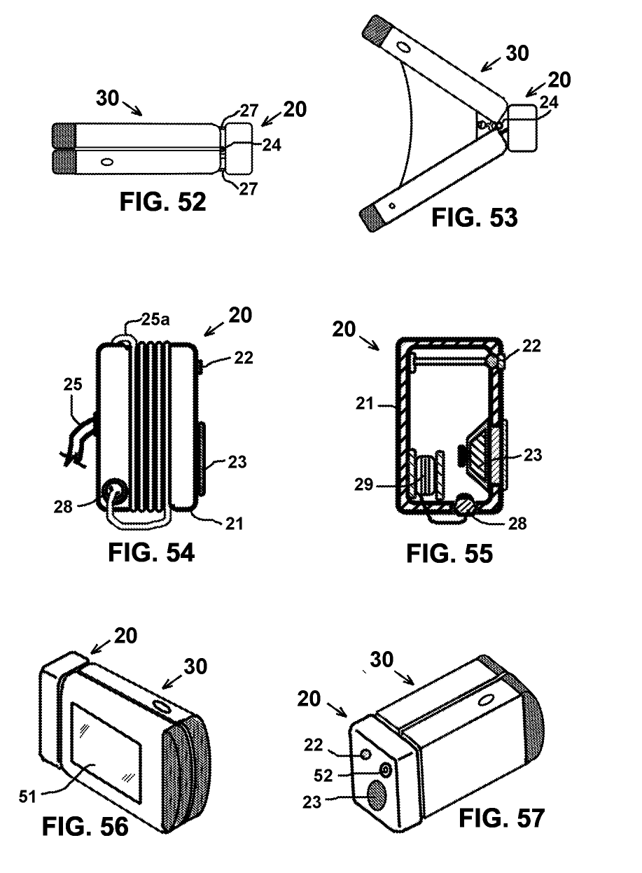

Shown in FIGS. 52 and 53 are the top views of an embodiment of the invention 10, in the closed and open positions respectively, with a single hinge 24 connecting the inner edges of shells 34a and 34b thereby rotatably linking the I/O 20 to clamshell 30. Guide rods 27 located on the fringe area of the I/O 20 and clamshell 30 helps align the travel or positioning of the I/O 20 when the clamshell 30 is opened and closed.

FIG. 54 shows an embodiment of invention 10 whereby a cable or cord 25a for an earphone or earbud 28 is wrapped around the housing 21 of I/O 20 allowing for better cable storage. A storage receptacle for earbud 28 located on the I/O 20 may be located on the clamshell 30 instead.

FIG. 55 shows an embodiment of invention 10 whereby a cable retracting system 29 is incorporated inside the housing 21 of I/O 20 further allowing for better storage of cable 25a.

FIG. 56 illustrates an embodiment of invention 10 whereby a display 51 is fixed on the exterior of either shells 34a or 34b thereby providing a user a visual facility for a video output.

FIG. 57 shows an embodiment of invention 10 whereby a video camera 52 is fixed on the exterior of I/O 20 providing a user a means for capturing a video data.

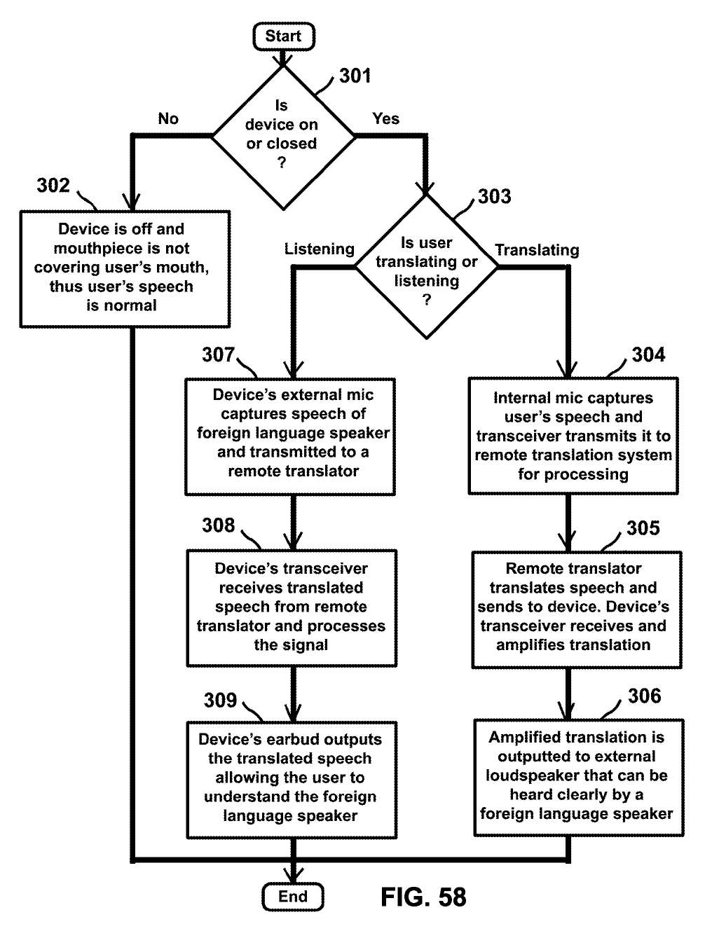

FIG. 58 summarizes a flowchart diagram of a process for speech-to-speech language translation embodiment of the invention whereby said process starts by checking to see if user 100 is using the invention 10, such as when the clamshell 30 is opened (step 301). If the device 10 is not being used then the clamshell 30 is generally in a nested (closed) arrangement and is either on a standby mode or completely powered down (step 302). If invention 10 is in a standby mode, then as soon as the clamshell 30 is opened, the internal microphone 35 will immediately be able to receive and process the speech of the user 100 for transmission to a remote translation system 80. Further, when said device is in-use, a translating mode and a listening mode can happen simultaneously. It is preferred however that the translation and listening modes do not happen simultaneously in order to achieve an effective dialogue between the user 100 and the foreigner 200.

In the translating mode, the user 100 speaks into the microphone 35 located inside the clamshell 30 whereupon his speech is transmitted by the transceiver 36 to a remote language translation system 80 either via base station 70 directly or by way of a wireless headset 50 or by way of a mobile phone 60 or a USB dongle 70 or another RF transceiver 70 or any combination thereof (step 304).

A short while thereafter, the language translation system 80 produces the translated speech and sends it to the device 10 whereby the transceiver 36 receives and amplifies said translation (step 305).

The final step of the translation mode further includes the process whereby the amplified translated speech signal gets fed to an external loudspeaker 23 positioned on the exterior of the clamshell 30 producing an audible output for a foreigner 200 to hear the translation (step 306).

In the listening mode, the foreigner 200 speaks in the general direction of the device 10, specifically towards microphone 22 located on the exterior of housing 21, whereby the speech of the foreigner 200 is captured and thereupon gets transmitted by the transceiver 36 to a remote language translation system 80 by way of a wireless base station 70 or a wireless headset 50 or a mobile phone 60 or a combination thereof (step 307).

A short while thereafter, although at times almost instantaneously, the language translator 80 produces the translated speech and sends it to the device 10 whereby the transceiver 141b receives and processes said translation signal (step 308).

As a final step in the listening mode, the processed translated speech signal is outputted to a wireless or corded earbud 43 connected to a transceiver 36 thereby allowing the user 100 to hear the translated speech of the foreigner 200 (step 309).

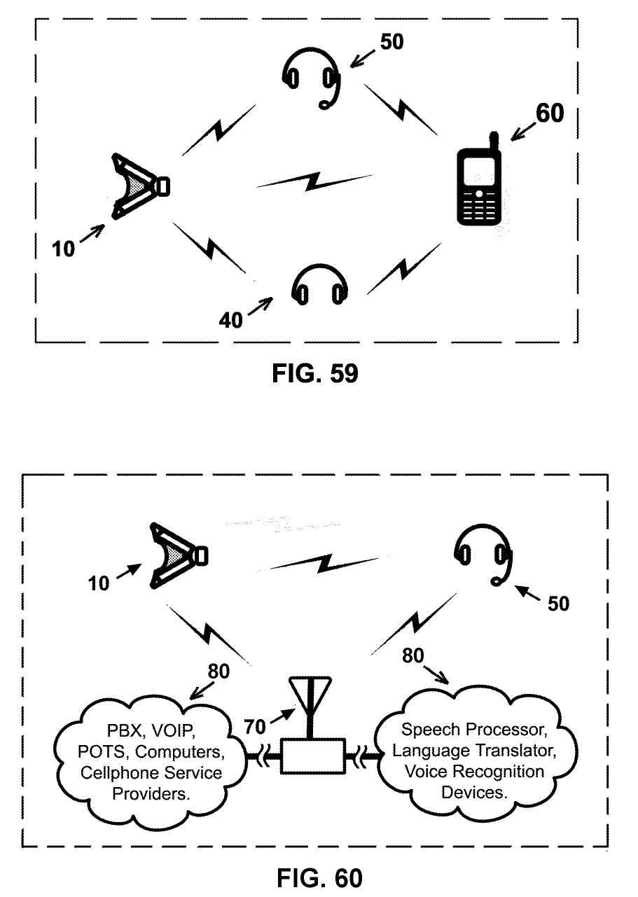

FIG. 59 shows a diagram of an embodiment of the invention 10 whereby the internal transceiver 36 is having a duplex or two-way communication with either a mobile phone 60 or with a wireless headset 50 or a combination thereof. The device 10 also sends and/or receives other wireless signals such as control, monitoring, and/or management signals from a mobile phone 60 or a headset 50 or both. The mobile phone 60 generally connects to a cellphone service provider such as Verizon or AT&T.

FIG. 60 shows a diagram of the invention 10 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a language translation system comprise of a human translator, a machine translator, a transcription machine, other voice input processors and/or a combination thereof. The device 10 also receives wireless signals such as commands, control signals, video signals, monitoring and management signals from other systems 80 through base station or transceiver 70 or a headset 50 or a combination thereof.

I claim:

1. A foldable language translation device comprising a first unit, a second unit, and a hinge that connects said first unit and said second unit defining a clamshell housing further comprising:
a primary microphone to capture a user's speech;
a loudspeaker to deliver a translated speech to a person other than the user of said device;
and a transceiver for processing, transmitting and receiving signals.

2. The foldable language translation device according to claim 1 wherein said clamshell further comprises a supple material conforming to the brims of the open end units of said clamshell associated with a user's mouth area.

3. The foldable language translation device according to claim 1 wherein said clamshell housing further comprises a sensor or switch, or a combination thereof, associated with said transceiver.

4. The foldable language translation device according to claim 1 wherein said clamshell housing further comprises an earphone to deliver signals to said user.

5. The foldable language translation device according to claim 1 wherein said clamshell housing further comprises a secondary microphone to capture a speech of a person other than the user of said device.

6. The foldable language translation device according to claim 1 wherein said clamshell housing further comprises a formable interior housing that reduces noise.

7. A foldable language translation device comprising a first unit, a second unit, and a hinge that connects said first unit and said second unit defining a clamshell housing further comprising:
a primary microphone to capture a user's speech;
a loudspeaker to deliver a translated speech to a person other than the user of said device;
a secondary microphone to capture the speech of a person other than the user of said device;
an earphone to deliver signals to said user;
and a transceiver for processing, transmitting and receiving signals.

8. The foldable language translation device according to claim 7 wherein said clamshell further comprises a supple material conforming to the brims of said clamshell associated with a user's mouth area.

9. The foldable language translation device according to claim 7 wherein said clamshell housing further comprises a sensor or switch, or a combination thereof, associated with said transceiver.

10. The foldable language translation device according to claim 7 wherein said clamshell housing further comprises a formable interior housing that reduces noise.

11. The foldable language translation device according to claim 10 wherein said interior housing is removable.

12. The foldable language translation device to according to claim 7 wherein said clamshell housing having a means for varying the input or output signals to or from said transceiver.

13. The foldable language translation device according to claim 7, wherein said earphone is wireless.

14. A foldable language translation device comprising a first unit, a second unit, and a hinge that connects said first unit and said second unit defining a clamshell housing further comprising:
a formable interior housing that reduces noise;
a primary microphone to capture a user's speech;
a loudspeaker to deliver a translated speech to a person other than the user of said device;
a secondary microphone to capture the speech of a person other than the user of said device;
an earphone to deliver signals to user;
and a transceiver for processing, transmitting and receiving signals.

15. The foldable language translation device according to claim 14 wherein said clamshell further comprises a supple material conforming to the brims of said clamshell associated with a user's mouth area.

16. The foldable language translation device according to claim 14 wherein said clamshell further comprises a sensor or switch, or a combination thereof, associated with said transceiver.

17. The foldable language translation device according to claim 14 wherein said interior housing is removable.

18. The foldable language translation device to according to claim 14 wherein said clamshell housing having a means for varying the input or output signals to or from said transceiver.

19. The foldable language translation device according to claim 14, wherein said earphone is wireless.

20. The foldable language translation device according to claim 14 further comprising a sensor or electronic circuitry for activating or deactivating said device associated with said transceiver.
